(19) United States
(12) Patent Application Publication
(10) Pub. No.: US 2004/0060628 A1
(43) Pub. Date: Apr. 1, 2004

(54) Heavy duty pneumatic tire

(76) Inventor: John H.W. Grimm, Wadsworth, OH (US)

Correspondence Address: BRIDGESTONE AMERICAS HOLDINGS, INC., 1200 FIRESTONE PARKWAY, AKRON, OH, 44317, US

(21) Appl. No.: 10/261,671

(22) Filed: Sep. 30, 2002

(51) Int. Cl. B60C 11/01; B60C 11/03

(52) U.S. Cl. 152/209.16; 152/209.18

(57) ABSTRACT

In an uneven wear-resisting heavy duty pneumatic tire tread including main grooves; land areas separated by grooves; and a stepped zone, within a land portion, located radially inside the tread contour line and bounded by narrow grooves, having a first lowered radial depth forming a wear-sacrificing portion, the improvement comprises at least a radially-directed circumferential portion of one of two radially outermost circumferentially-extending ground contact areas of the land portion, laterally terminating into one of the stepped zone grooves, with a circumferentially relieved first portion, the maximum depth thereof having a second lowered surface depth, with respect to the tread contour line, this second lowered surface depth differing from the first lowered surface depth, the relieved portion taking the shape of a surface of revolution, with the laterally directed surface thereof being one of a straight, curved, undulating, stepped, and scalloped line.

### BACKGROUND OF THE INVENTION

1. Technical Field

The invention pertains to improved heavy duty pneumatic tires, particularly for use in drive wheel and steered wheel applications, the improvement relating to increasing uneven wear resistance.

2. Background Information

Radial carcass structures are often utilized in the construction of heavy duty pneumatic tires and the use of such constructions in trucks or busses, particularly in driven or driving wheels, and especially in steered wheels, so-called uneven wear often occurs, particularly in the shoulder portions of such tires, long before the tires reach the end of their projected life span.

In order to reduce the incidents of uneven wear of such tire treads, there have been many proposed solutions, including contour configurations, tread patterns, grooving and siping arrangements, as well as combinations thereof. Some countermeasures, particularly those set forth in U.S. Pat. Nos. 5,131,444 and 5,445,201, both assigned to Bridgestone Corporation, which are incorporated herein by reference in their entireties, have provide significant improvements. These tire tread configurations utilize discrete, stepped, recessed zones in land portions thereof wherein each stepped zone has its outer circumferential surface located radially inside a contour line of the tread, when viewed in section, with these stepped portions being bounded on opposite sides thereof by narrow grooves. The noted stepped zones or portions have a lowered radial depth and define an uneven wear-sacrificial or equalization portion or rib which contacts the ground within the ground-contacting area of the tire footprint for supporting a load exerted upon the tire.

Further additional prior art proposed solutions to the noted uneven tread wear problem are believed to be set forth in the following U.S. Pat. Nos.: 5,115,850; 5,293,918; 5,323,825; 5,345,988; 5,665,184; 5,833,780; 5,891,276 and 6,112,787.

Although these tire and their various proposed constructions may provide partial solutions to the existing uneven wear problems, the need still exists for a heavy duty pneumatic tire, as previously defined, having a radial construction that provides increased resistance to the occurrence of the noted uneven and/or irregular tire wear.

### BRIEF SUMMARY OF THE INVENTION

The present invention builds upon the structures set forth in previously discussed U.S. Pat. Nos. 5,131,444, 5,445,201 and provide additional countermeasures against the uneven wear phenomenon. More particularly, the present invention is utilized in a heavy duty pneumatic tire adapted for substantially preventing uneven wear including circumferential main grooves in a tread along the circumference thereof; land portions defined and separated by the main grooves; and a stepped zone located within a land portion having a substantially flat, radial outer top surface located radially inside a contour line of the tread, the contour line being defined by radially outer surfaces of the land portions, as viewed in section, the stepped zone extending substantially continuously in the circumferential direction within a land portion and being bounded on opposite sides by narrow grooves, preferably having substantially equal depths, the stepped portion having a first lowered radial depth, wherein a wear-sacrificing portion is formed by the noted radially outer top surface of the stepped zone, with the wear-sacrificing portion contacting the ground within the tread ground-contacting area for supporting a load exerted upon the tire, wherein the improvement comprises at least a laterally-directed portion, of one of the two radially outermost circumferentially-extending ground contact areas of said land portion laterally terminating into the narrow grooves bounding the stepped zone, the ground contacting area portion having a first circumferentially relieved portion, with a maximum depth of the first relieved portion occurring at the intersection of the ground contacting area portion and one of the narrow grooves, the maximum depth of the first taper having a second lowered surface depth, with respect to the sectional contour line of the tread, the second lowered depth differing from the first lowered depth. The other of the two radial outermost circumferentially-extending ground contacting surfaces of the opposing land portions, that laterally terminates into the other of the narrow grooves bounding the stepped zone, having a second relieved portion, with a maximum depth of the second relieved portion thereof occurring at the intersection of the other ground contacting surface and the other narrow groove, the maximum depth of the second relieved portion having a third lowered surface depth, with respect to the sectional contour line of the tread, with the third lowered surface depth differing from the first lowered surface depth.

In further a embodiment of the invention, the first and second relieved portions, as viewed in elevation, have the general shape of laterally-directed surfaces of revolution, wherein at least one of these surfaces, when viewed in section, is one of a chamfer and a taper, which in turn can take the shape of either a substantially straight line, a curved line, an undulating line, a stepped line or a scalloped line.

In another embodiment of this invention, at least one of the first and second relieved portions, as viewed in elevation, has the general shape of a laterally directed truncated cone.

In yet further embodiments of this invention, the angles of the first and second relieved portions, relative to the tire contour surface, leading to the second and third relieved portions, are different and/or are oppositely directed and/or and have converging angles and/or fall within specified ranges, and/or specific angulations.

In additional embodiments of this invention, the lateral extents of the first and second relieved portions, are different, and can extend over all or but portions of their associated ground contacting area portions.

In yet other embodiments of this invention, the depths of the second and third lowered surfaces are less than the depth of the first lowered surface and fall within specified limits relative to the tread depth and each other.

Finally, in still other embodiments of this invention, the improvements thereof, relative to the widths of the ground contacting areas, the first and second lowered depths and the angulations of the noted truncated cones are set forth in four respective relationships that are set forth below the illustration appearing in FIG. 4B.

The foregoing advantages, construction and operation of the present invention will become more readily apparent from the following description and the several accompanying drawings.

### BRIEF DESCRIPTION OF THE SEVERAL VIEWS OF THE DRAWINGS

A preferred embodiment of the invention, illustrative of the best mode in which the inventor has contemplated applying the principles thereof, is set forth in the following description and is shown in the drawings as well as being particularly pointed out and set forth in the appended claims.

FIG. 1 is a front elevational view of a pneumatic tire having the improved equalization control rib contained within the tire tread portion thereof;

FIG. 2 is a greatly enlarged plan elevational or developed view of the encircled portion of FIG. 1;

FIG. 3 is an enlarged fragmentary sectional and simplified view of the tire tread, taken along line 3-3 of FIG. 1;

FIG. 4A is a further enlarged and simplified fragmentary view of the left one half portion of the tire tread of FIG. 3, terminating at the mid-circumferential centerline of the tire; and

FIG. 4B is another version of FIG. 4A but is further denominated with definitions, constraints, ranges and four relationships pertaining to the claimed lateral ranges, relief depths and relief angulations.

Similar numerals refer to similar parts throughout the drawings.

### DETAILED DESCRIPTION OF THE INVENTION

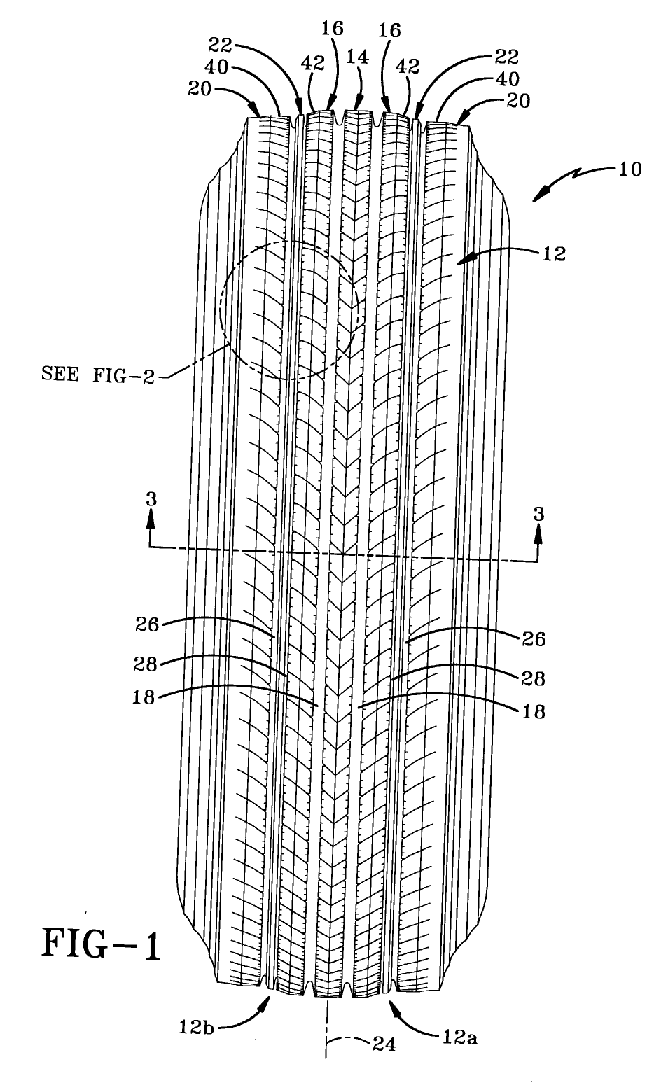

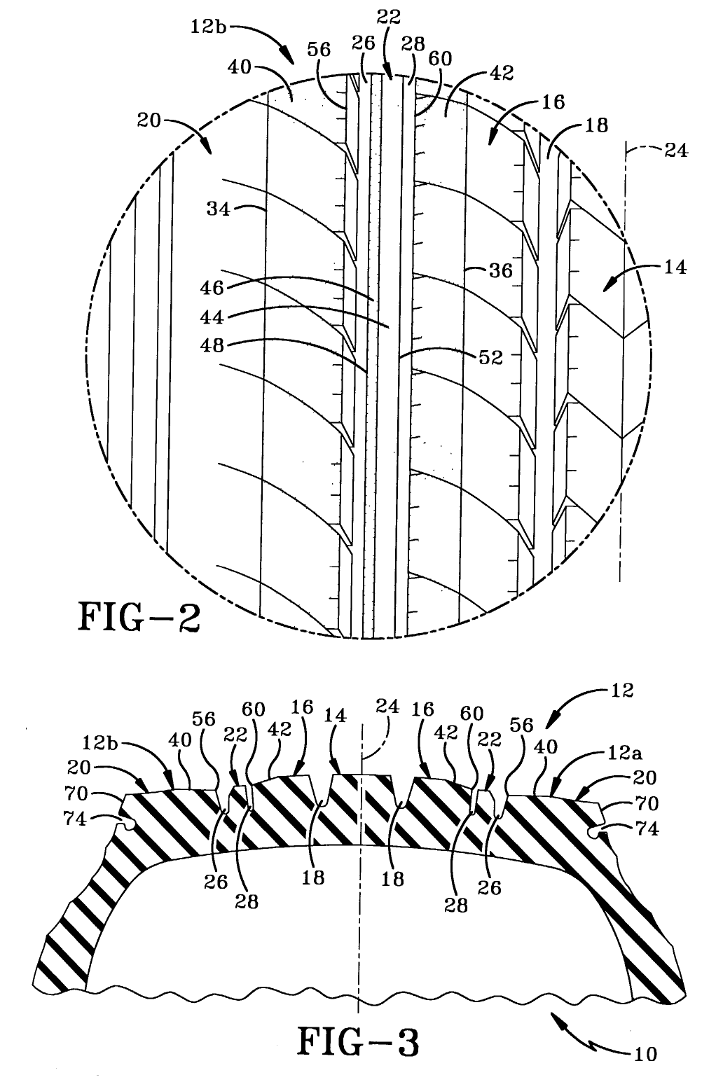

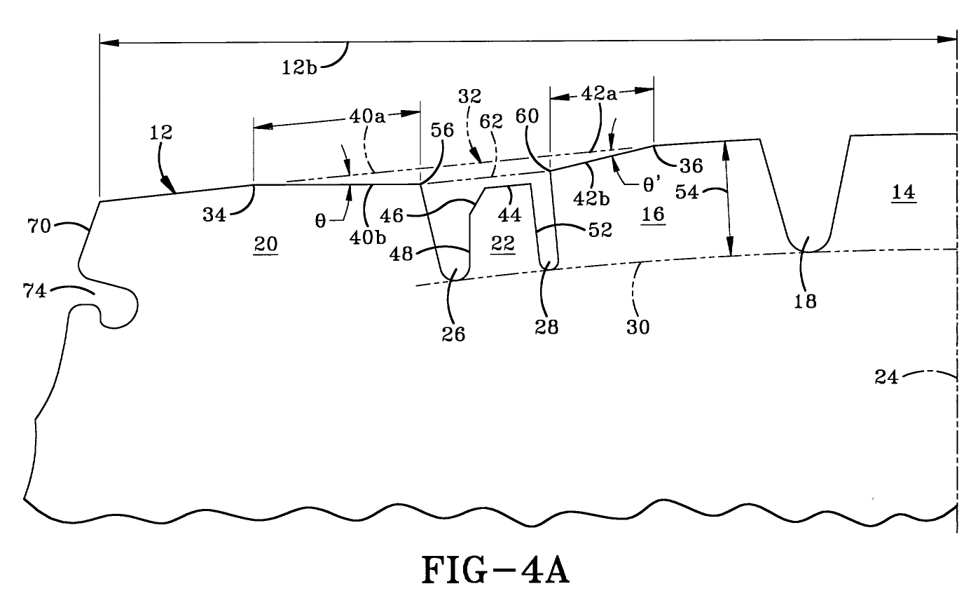

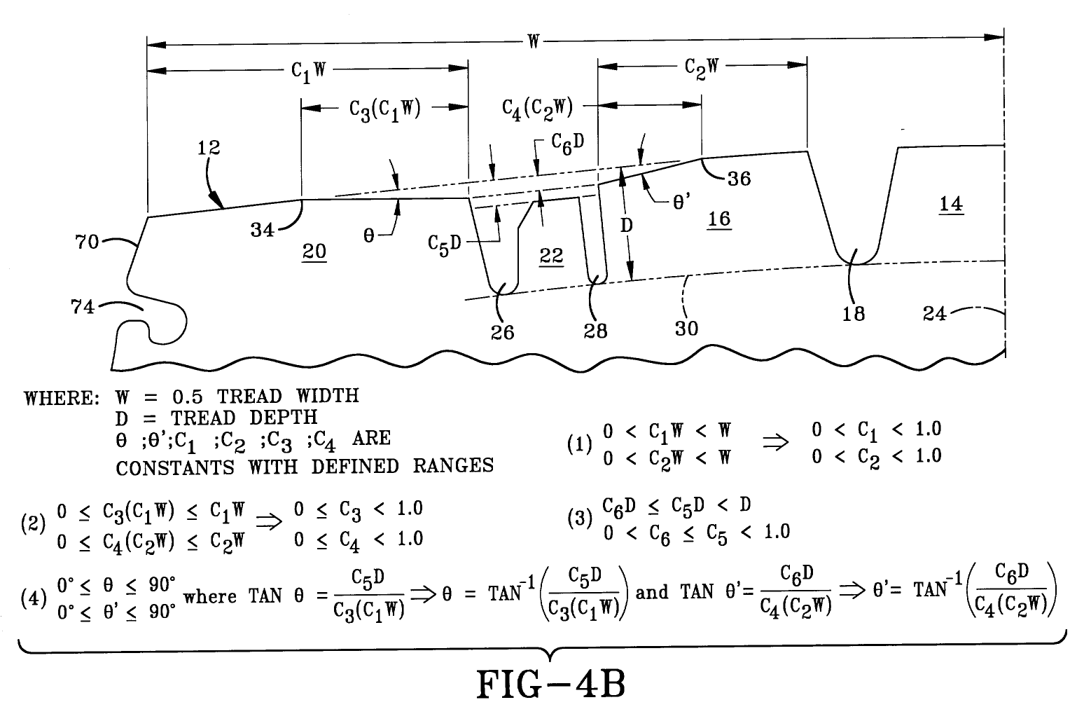

Turning now to the drawings, particularly in FIGS. 1 and 2, there are shown a front elevational view and an enlarged plan elevational or developed view of a left hand principal portion 12b of a tread 12 respectively, of a heavy duty radial pneumatic tire 10 incorporating the present invention. Tire 10 includes a circumferential center rib or land portion 14 that is axially separated from adjacent intermediate rib or land portions 16 by circumferentially directed main grooves 18. The improved opposed shoulder or circumferential edge land portions 20 of this invention are laterally spaced from their respective adjacent improved intermediate rib portions 16 by the known stepped zone control rib 22 of this invention, as best seen in the enlarged fragmentary sectional view of the tire tread in FIGS. 3, 4A and 4B. It should be noted that since FIG. 4B shows angulations and dimensions etc., similar to those of FIG. 4A, in terms of relationships or ratios, the corresponding such angulations and/or dimensions are stated herein, on occasion, within double parenthesis for ease of understanding.

A review of FIG. 3 will show that the mid-circumferential center line or plane 24 separates tread portion 12 into allochiral or mirror-image tread halves 12a (right) and 12b (left) and therefore, in the interest of brevity, only tread portion 12b will be discussed in detail with reference to FIGS. 4A and 4B which set forth enlarged simplified fragmentary views of left tread half 12b ((W)).

As best seen in FIGS. 2, 3, 4A and 4B, control rib 22 is laterally or axially spaced from adjacent shoulder rib 20 by a narrow outer circumferential straight groove 26 and similarly spaced from adjacent intermediate rib 16 by a narrow inner circumferential straight groove 28. Narrow outer groove 26 may have a radially inwardly-directed diminishing variable cross sectional width while narrow inner groove 28 has a preferably constant cross sectional width. The terminus or radially inner radii end of each of grooves 18, 26 and 28 abuts a theoretical radial inner (broken) line 30 (FIG. 4A) joining said groove radii, with line 30 being substantially parallel with a theoretical outer line 32 (FIG. 4A) joining the largest radial outwardly-directed dimensions of shoulder rib 20, starting at circumferential line 34 (FIG. 2), and intermediate rib 16, starting at line 36 (FIG. 2), with both lines 34 and 36 being seen only as points in FIG. 4A, and which will be discussed in more detail hereinafter.

Turning now specifically to FIGS. 2, 4A and 4B, in the illustrated embodiment of this invention, an axially inwardly-directed annular portion or band area 40a, ((C₃(C₁W )), stippled in FIG. 2, of about one half of the axial or lateral width of shoulder rib 20, ((C₁W)) starting at line 34 and terminating at line 56, (which also defines the intersection of area 40 with the edge portion of the axial outer wall of narrow groove 26), is tapered, relieved or chamfered, as at 40b, in any desired manner, relative to theoretical outer line 32, at an included angle ((θ′)) of about 14 to 16 degrees. Outer line 32 forms a lateral portion of the theoretical sectional contour line (not shown per se) of tread portion 12b ((W)). The axial extent or width of band portion 40 extends about 19% of the axial width of tread portion 12b. Similarly, an axially outwardly-directed annular band portion or area 42a ((C₄(C₂W)), stippled in FIG. 2, of about one half of the axial width of intermediate rib 16, staring at line 36 and terminating at line 60, (which also defines the intersection of area 42 with the edge portion of the inner wall of narrow groove 28), is similarly also tapered, relieved or chamfered, as at 42b, relative to theoretical outer line 32, at an included angle ((θ′)) of about 21 to 23 degrees. The lateral extent or width of band portion 42 extends about 12% of the axial width of tread portion 12b. It will be clear from FIG. 4A that relieved band portions 40 and 42 are oppositely angularly-directed or sloped toward brake control rib 22 in a converging manner.

In another embodiment of this invention, the entire lateral or axial extent of at least one of band portions 40 or 42 of shoulder ribs 30 and intermediate rib 16, respectively is chamfered, tapered or relieved, taking the shape of one of a substantially straight line, as illustrated, or a curved line, an undulating line, a stepped line and a scalloped line, etc. as desired. Relieved band portions 40 and/or 42, as viewed in elevation, also have the general shape of laterally directed first and second truncated cones, respectively. Furthermore, band portions 40 and/or 42, as viewed in elevation, are also surfaces of revolution taking one or more of the shapes defined directly hereinabove.

In a further embodiment of this invention, the lateral extents of at least one of band portions 40 and 42 extend for less than the previously noted about one half of the width of ribs 20 and 16. See relationships (1) and (2) in FIG. 4B. The respective angulations of band portions 40 and 60 of ribs 16 and 20, respectively, ((θ, θ′)) will of course change, depending on the axial extents thereof. See relationship (4) in FIG. 4B.

Continuing with FIGS. 2 and 4A, and with reference to known equalizer control rib 22, the flat radially-outermost or top surface 44 thereof (stippled in FIG. 2) may be tapered, relieved or chamfered, relative to the axial outer wall or side surface of rib 22 via an angular annular surface 46 between top surface 44 and a rib outer wall surface 48 but the shape, per se, of rib 22 forms no part of the present invention.

Furthermore, in the illustrated embodiment of this invention, control rib top surface 44 is located radially inwardly a predetermined distance ((C₅D)), relative to outer theoretical line 32, (which may also be defined as a portion of the continuous theoretical, but not the actual, contour line of tread portion 12b), about 17% of the thickness or depth 54 ((D)) of tread portion 12b, which is also equivalent to the radial extent or depth of main groove 18 ((D)). In addition, the maximum amount of chamfer or relief of shoulder rib portion 40, at line 56 ((C₆D)), at groove 26, relative to outer theoretical line 32, is about 10% of noted tread thickness 54. The maximum amount of chamfer or relief of shoulder rib portion 42, at line 60 ((C₆D)), at groove 28, relative to outer theoretical line 32, is also about 10% of noted tread thickness 54 but it need not be the same as that of shoulder rib portion 40. In addition, relative to an intermediate theoretical line 62, perpendicularly connecting lines 56 and 60 (shown as points in FIG. 4A), equalizer control rib outer surface 44 is located radially-inwardly ((distance C₅D-C₆D)) thereof about 7%, with reference to noted tread thickness 54. Finally, relative to outer theoretical line 32, surface 44 is located radially inwardly thereof about 17%, with reference to noted tread thickness 54. See relationship (3) in FIG. 4B.

A viewing of FIG. 4A will make it clear that inner, intermediate and outer theoretical lines 30, 62 and 32 are in fact substantially parallel and that the maximum radial inward relief of chamfered shoulder rib and intermediate rib portions 40, 42 occurs at lines 56 and 60, respectively, and that lines 62 and 30 are thus located radially inwardly of the theoretical contour line of tread 12, while line 32 is coincident with a portion thereof. The radial distance between lines 32 and 62 corresponds to about 10% of tread thickness 54, representing a graduated or smooth and oppositely-directed decrease from lines 34 and 36 to lines 56 and 60, respectively. Similarly, control rib top surface 44 is, in turn, located radially inwardly, relative to line 62, a further distance corresponding to 7% of noted tread thickness 54, thus representing one discrete stepped zone. In addition, surface 44, relative to line 32, is thus located radially inwardly, thereof a total of about 17% of tread thickness 54, this representing the combination of the defined gradual step ((C₆D)) and the noted discrete step ((C₅D-C₆D)).

Turning now principally to FIG. 4A, the maximum width of groove 26 is about 6%; the width of groove 28 is about 3%; and the maximum width of groove 18 is about 11% of the axial width of tread portion 12b. In addition the axial widths of shoulder rib 20, intermediate rib 16 and one half of center rib 14 are about 38%, 25% and 11% respectively, of the axial extent of tread portion 12b. Finally, the combination of the axial extents of relieved surfaces 40 and 42, together with braking rib top surface 44, the portion relieved from surface 44, as well as the maximum width of groove 26 and the width of groove 28, which together also constitute the axial extent of theoretical outer line 32 (joining lines 34 and 36), comprise about 48% of the axial extent of tread portion 12b. The total axial extent of relieved rib areas 40 and 42 (whose maximum relief depth is about 10% of noted tread thickness 54) comprises about 31% of the axial extent of tread portion 12b as well as about 66% of the axial extent of theoretical outer line 32. The total axial extent of control rib 22, together with the axial extents or lateral widths of adjacent grooves 26 and 28, (whose minimum relief depth, relative to line 32, is about 10% of noted tread thickness 54), and which also constitutes the axial extent of intermediate theoretical line 62, comprises about 16% of the axial extent of tread portion 12b as well as about 34% of the axial extent of theoretical outer line 32.

It has been determined that the prior art's utilization of but a single discrete stepped zone, such as lowered surface level “δ” in U.S. Pat. Nos. 5,131,444 and 5,445,201, while reducing uneven tread wear and irregular tread wear, still did not fully reduce the phenomenon in these tread designs, particularly on steered and/or driven wheels of heavy duty vehicles. The present invention, in the illustrated embodiment thereof, further reduces such uneven and irregular tread wear by utilizing, in addition to the known discrete radial (first) stepped zone between the equalizing control rib upper surface 44 and intermediate theoretical line 62, intermediate graduated or chamfered (second and third) steps emanating at circumferential lines 34, 36 of adjacent shoulder and intermediate ribs 20 and 16, respectively. These relieved, tapered or chamfered surfaces 40 and 42, extending from theoretical line 32 to theoretical line 62, terminate and are maximized at their intersections with narrow grooves 26 and 28, respectively and represent about 10% of noted tread thickness 54. These chamfers etc. are laterally spread out, in the illustrated embodiment of this invention, over about 50% of the noted tread thickness 54. Stated in the alternative, in the noted embodiment, the chamfer angles ((θ,θ′)) relative to line 32, range from about 14 to 16 and 21 to 23 degrees for surfaces 40 and 42, respectively. It is preferred that the about 7% depth difference between first step (about 17%) and the second and third steps (about 10%), respectively, be equated to no less than about 1 mm. It is believed that the theory of operation of the tire itself remains substantially similar to that espoused in noted U.S. Pat. Nos. 5,131,444 and 5,445,201.

The benefits of the improvements of the present invention, with respect to the widths of the relieved portions 40 and 42, the first and second lowered surface depths as well as the angulations of first ((θ)) and second ((θ′)) relieved portions ((C₃(C₁W)) and ((C₄(C₂W)), are set forth graphically in FIG. 4B together with four relationships that serve to define the noted relationships. For ease of understanding, these four relationships, which pertain to the dimensions and angulations in FIG. 4B have been included as a part of FIG. 4B.

Uneven wear is additionally believed to be reduced by chamfering equalizer control rib top surface 44 at its axially outermost corner, i.e., at the previous intersection of top surface 44 (adjacent shoulder rib 20) and the axially outermost surface of brake control rib outer wall 48, which consequently results in sloping surface 46 that joins surfaces 44 and 48. As noted, the chamfering of control rib 22 forms no part of the present invention.

Turning now to FIG. 3, particularly the latter, shoulder rib 20 includes, on its shoulder side 70, a known laterally-extending shoulder indentation groove extending angularly into tire shoulder side 70. The axial or lateral extent of groove 74 is limited due to the proximity of the underlying tread reinforcement belts or plies (not shown here for the sake of simplicity). It is the known function of shoulder indentation groove 74 to permit additional deflection of an axial outer annular edge portion of shoulder rib 20 as tire 10 rotates through its footprint, i.e., during the rotation of the tire under load and forms no part of the present invention.

It should be understood that those skilled in the tire art will readily appreciate that the improved construction of this invention is not limited for utilization with only straight circumferentially-directed tread ribs of constant width but is also capable of being utilized with undulating and zig-zag ribs and varying width ribs together with their associated grooves grooves. In addition, the tread ribs, as well as the equalization control rib(s) need not be circumferentially continuous but could be provided with any desired lateral grooves and/or sipes and cuts, such as for example, those indicated in FIGS. 1 and 2. If desired the improved construction of this invention can be used in adjacent tread land areas other and/or in conjunction with those of the shoulder and intermediate ribs.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is but an example and the invention is not limited to the exact details shown and/or described.

1. In a heavy duty pneumatic tire adapted for substantially preventing uneven wear comprising:
a. main grooves continuously extending in a tread along the circumference thereof;
b. land portions defined and separated by an outermost main groove and a tire shoulder; and
c. a stepped zone located within a land portion having a substantially flat, radial outer top surface located radially inside a contour line of the tread, said contour line being defined by radially outer surfaces of said land portions, as viewed in section, said stepped zone extending substantially continuously in the circumferential direction within said land portion and being bounded on opposite sides by narrow grooves, with said narrow grooves each having a substantially equal depth, said stepped portion having a first lowered radial depth, wherein a wear-sacrificing portion is formed by said radially outer top surface of said stepped zone, said wear-sacrificing portion contacting the ground within the tread ground-contacting areas of said land portion for supporting a load exerted upon the tire, wherein the improvement comprises:
d. at least a laterally-directed portion, one of the two radially outermost circumferentially-extending ground contact areas of said land portion, laterally terminating into said narrow grooves bounding said stepped zone, said ground contacting area portion having a first circumferentially relieved portion, with a maximum depth of said laterally directed portion occurring at the intersection of said ground contacting area portion and one of said narrow grooves, said maximum depth of said first relieved area having a second lowered surface depth, with respect to the sectional contour line of the tread, said second lowered surface depth differing from the depth of said first lowered surface.

2. The improved pneumatic tire tread of claim 1, wherein at least a laterally-directed circumferential portion, of the other of the two radial outermost circumferentially-extending ground contacting areas of said land portion, laterally terminates into the other of said narrow grooves bounding said stepped zone, said other ground contacting area portion having a second circumferentially relieved portion, with a maximum depth of said second relieved portion thereof occurring at the intersection of said other ground contacting area portion and said other narrow groove, said maximum depth of said second relieved portion having a third lowered surface depth, with respect to the sectional contour line of the tread, said third lowered surface depth differing from said first lowered surface depth.

3. The improved pneumatic tire of claim 2, wherein said first and second relieved portions, as viewed in elevation, have the general shape of laterally directed first and second truncated cones, respectively.

4. The improved pneumatic tire of claim 2, wherein each of said first and second relieved portions, as viewed in elevation, are surfaces of revolution.

5. The improved pneumatic tire of claim 4, wherein at least one of said surfaces of revolution, viewed in section, is one of a chamfer and a taper.

6. The improved pneumatic tire of claim 5, wherein at least one of said chamfer and said taper is one of a substantially straight line, a curved line, an undulating line, a stepped line and a scalloped line.

7. The improved pneumatic tire of claim 2, wherein the depths of said second and third lowered surface are substantially similar.

8. The improved pneumatic tire of claim 2, wherein the angles of said first and second relieved portions, relative to said contour line of the tread, leading to said second and third lowered surface depths, respectively, are different.

9. The improved pneumatic tire of claim 8, wherein the angles of said first and second relieved portions are oppositely directed.

10. The improved pneumatic tire of claim 9, wherein said oppositely directed angles are converging angles.

11. The improved pneumatic tire of claim 1, wherein the included angle of said first relieved portion, relative to said tread contour line of the tread, is in the range of about 14 to 16 degrees.

12. The improved pneumatic tire of claim 1, wherein the included angle of said first relieved portion, relative to said tread contour line, is about 15 degrees.

13. The improved pneumatic tire of claim 1, wherein the included angle of said second relieved portion, relative to said tread contour line, is in the range of about 21 to 23 degrees

14. The improved pneumatic tire of claim 1, wherein the included angle of said second relieved portion, relative to said tread contour line, is about 22 degrees.

15. The improved pneumatic tire of claim 2, wherein lateral extents of said first and second relieved portions are different.

16. The improved pneumatic tire of claim 2, wherein the lateral extent of at least one of said first and second relieved portions extends across the entire ground contact surface of at least one of one of said ground contact area portions.

17. The improved pneumatic tire of claim 2, wherein the lateral extent of at least one of said first and second relieved portions extends across less than the entire ground contact surface of at least one of said ground contacting area portions.

18. The improved pneumatic tire of claim 2, wherein the depths of said second and third lowered surfaces are less than the depth of said first lowered surface.

19. The improved pneumatic tire of claim 2, wherein the difference in the depths between at least one of said second and third lowered surfaces and said first lowered surface is no greater than about 7% of the tread depth of said tire.

20. The improved pneumatic tire of claim 19, wherein said difference in depths is no greater than about 1 mm.

21. The improved pneumatic tire of claim 7, wherein said second and third lowered surface depths are less than that of said first lowered surface depth.

22. The improved pneumatic tire of claim 7, wherein the depths of said second and third lowered surfaces are about 10% of the tread depth of said tire.

23. The improved pneumatic tire of claim 1, wherein the depth of said first lowered surface is about 17% of the tread depth of said tire.

24. The improved pneumatic tire of claim 9 wherein the lateral extents of at least one of said first and second relieved portions is approximately one-half of the lateral extent of its respective ground contact area portion.

25. In a heavy duty pneumatic tire adapted for substantially preventing uneven tire wear comprising:
a. main grooves continuously extending in a tread along the circumference thereof,
b. land portions defined and separated by main grooves within said tire tread; and
c. a stepped zone located within a land portion, having a substantially flat radial outer top surface located radially inside a contour line of the tread, said contour line being defined by radially outer surfaces of said land portions, as viewed in section, said stepped zones extending substantially continuously in the circumferential direction within said land portion and being bounded on opposite sides by narrow grooves, said stepped portion having a first lowered radial depth C₅D, wherein a wear-sacrificing portion is formed by said radially outer top surface of said stepped zone, said wear sacrificing portion contacting the ground within the tread ground contacting areas of said land portion for supporting a load exerted upon the tire, wherein the improvement comprises:
d. at least a laterally-directed portion, C₃(C₁W), C₄ (C₂W) of one of the two radially outermost circumferentially extending ground contact areas C₁W C₂W of said land portion, laterally terminating into one of said narrow grooves bounding said stepped zone, as viewed in elevation, having the general shape of a first truncated cone, with a maximum depth of said first truncated cone occurring at the intersection of said ground contacting area portion and one of said narrow grooves, said maximum depth of said first truncated cone having a second lowered surface depth C₆D, with respect to the sectional contour line of the tread, said second lowered surface depth differing from the depth of said first lowered surface, where:
W=0.5 Tread Width
D=Tread Depth
θ; θ′; C_{1;} C₂; C₃; C₄; are constants with defined ranges

26. The improved pneumatic tire of claim 25, wherein at least a laterally-directed circumferential portion C₄(C₂W), C₃(C₁W), of the other of the two radial outermost circumferentially-extending ground contact areas C₂W, C₁W, of said land portion, laterally terminates into the other one of said narrow grooves bounding said stepped zone, as viewed in elevation, having the general shape of a second truncated cone, with a maximum depth of said second truncated cone thereof occurring at the intersection of said other ground contacting area portion and said other narrow groove, said maximum depth of said second truncated cone having a third lowered surface depth C₆D, with respect to the sectional contour line of said tread, said third lowered surface depth differing from that of said first lowered surface.

27. The improved pneumatic tire of claim 26, wherein the widths of said ground contacting areas is defined as follows:

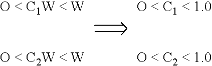

28. The improved pneumatic tire of claim 27, wherein said ground contacting surface is further defined as follows:

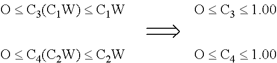

29. The improved pneumatic tire of claim 28, wherein said first and second lowered depths are defined as follows:
C₆D≦C₅D<D
O<C₆≦C₅<1.0

30. The improved pneumatic tire of claim 29, wherein the laterally directed surface of at least one of said first and second truncated cones, viewed in section, is one of a substantially straight line, a curved line, an undulating line, a stepped line and a scalloped line.

31. The improved pneumatic tire of claim 29, wherein the angles θ and θ′ of said first and second truncated cones, respectively, relative to said contour line of the tread, leading to said second and third lowered surface depths, respectively are defined as follows:
O°≦θ≦90° where TAN θ=C₅D/C₃(C₁W)→θ=TAN⁻¹(C₅D/C₃(C₁W)) and
O°≦θ≦90° TAN θ¹=C₆D/C₄(C₂W)→θ′=TAN⁻¹(C₆D/C₄(C₂W))

32. The improved pneumatic tire of claim 31, wherein said angles are different.

33. The improved pneumatic tire of claim 31, wherein the angles of said first and second truncated cones are oppositely directed.

34. The improved pneumatic tire of claim 32, wherein said oppositely directed angles are converging angles.
